(19) United States
(12) Patent Application Publication
(10) Pub. No.: US 2012/0040056 A1
(43) Pub. Date: Feb. 16, 2012

(54) NON-DAIRY, COCONUT-BASED BEVERAGE

(75) Inventors: Laura LaSalle Tewnion, Boulder, CO (US); Stephen A. McCready, Arvada, CO (US); Young C. Kang, Alpharetta, GA (US)

(73) Assignee: WhiteWave Services, Inc., Dallas, TX (US)

(21) Appl. No.: 12/857,279

(22) Filed: Aug. 16, 2010

(51) Int. Cl. A23L 2/52; A23L 1/303; A23L 2/60

(52) U.S. Cl. 426/73; 426/598; 426/548

(57) ABSTRACT

In accordance with a particular embodiment of the present disclosure, a method comprises mixing an aqueous medium, a coconut base, and an emulsifier to yield an emulsion. The emulsion is blended with one or more other ingredients to yield a coconut-based beverage. The coconut-based beverage is substantially free of dairy-derived ingredients.

### TECHNICAL FIELD

This disclosure relates generally to beverages, and more specifically to non-dairy, coconut-based beverages.

### BACKGROUND

Consuming dairy milk provides a multitude of health benefits. Dairy milk may provide calcium, protein, and additional vitamins. Consuming soy-based milk is an alternative to consuming dairy milk. However, some people do not consume dairy products or soy-based milk for reasons related to digestion, allergies, aversion to genetically modified organisms (GMO), or lifestyle choices to avoid certain foods. Some non-dairy beverages may have less than desirable taste, mouth feel (e.g., gritty or grainy texture), and shelf life.

### SUMMARY OF EXAMPLE EMBODIMENTS

The present disclosure is directed to a non-dairy coconut-based beverage formulation and a method of producing the same. In various embodiments, the teachings of the present disclosure may allow for stable, non-dairy, coconut-based beverage that may be substantially or entirely free of soy or soy-derived ingredients.

In accordance with a particular embodiment of the present disclosure, a method comprises mixing an aqueous medium, a coconut base, and an emulsifier to yield an emulsion. The emulsion is blended with one or more other ingredients to yield a coconut-based beverage. The coconut-based beverage is substantially free of dairy-derived ingredients.

Technical advantages of particular embodiments of the present disclosure include creating a stable, coconut-based substitute for milk that may be substantially or entirely free of soy or soy-derived ingredients. Particular embodiments may provide enhanced quality control while reducing product variation. Further technical advantages of particular embodiments include the production of a beverage with extended shelf life, along with a desirable flavor and mouth feel.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 is one example of a block diagram illustrating a batching system for making a beverage that includes coconut according to a particular embodiment; and

FIG. 2 is an example flow diagram illustrating a method for making non-dairy, coconut-based beverage according to particular embodiments.

### DETAILED DESCRIPTION

Particular embodiments disclosed herein include creating stable, coconut-based, non-dairy beverages that may be substantially or entirely free of soy or soy-derived ingredients and/or substantially or entirely free of dairy or dairy-derived ingredients. Additionally, particular embodiments include the production of a substantially soy-free, non-dairy, coconut-based beverage with extended shelf life, along with a desirable flavor and a mouth feel similar to dairy milk. The term coconut as used herein generally refers to the fruit of the coconut palm, botanically known as cocos nucifera, with nucifera meaning “nut-bearing.” It is a simple dry nut. The husk is composed of fibers called coir. Below the coir is the endocarp, also called the inner stone. This is the hardest part of the coconut. Inside the stone is the coconut meat, which is the white, fleshy edible part of the fruit. It is from the meat that coconut cream is produced.

To make coconut cream, grated coconut meat is pressed to release the white liquid cream from a freshly opened coconut. The resulting cream has a mild, non-sweet taste. The cream contains medium chain fatty acids such as lauric acid, caprylic acid and capric acid. The principal fatty acid in coconut cream is lauric acid. Coconut milk may be similar to coconut cream and may include more water than coconut cream.

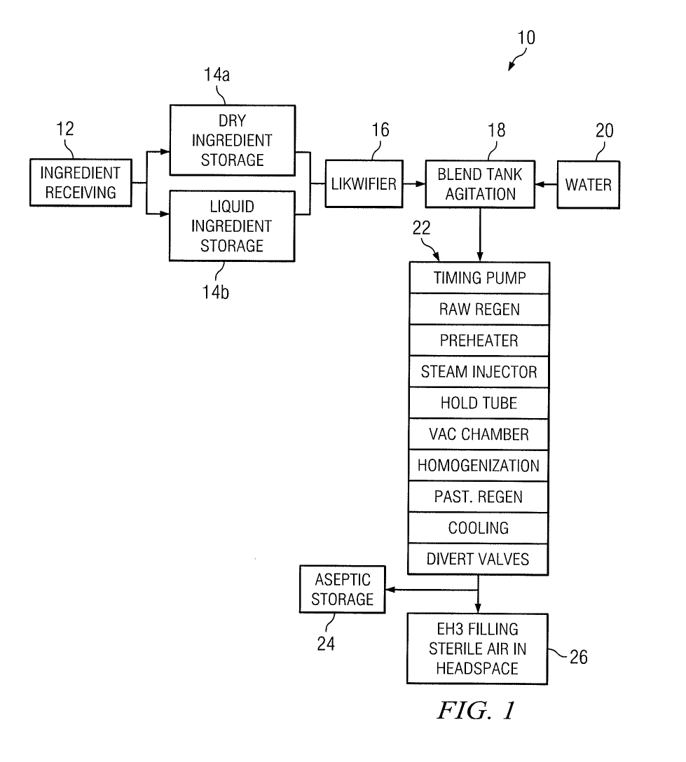

FIG. 1 is one example embodiment of a block diagram illustrating a batching system 10 for making a beverage that includes coconut cream as a base ingredient. In particular embodiments, the beverage produced by batching system 10 may be substantially or entirely free of soy or soy-derived ingredients. In this example, batching system generally includes a receiving module 12, storing modules 14, a likwifier 16, a blend tank 18, a water module 20, a processing module 22, aseptic storage 24, and a filling module 26.

In this example, receiving module 12 generally receives ingredients, which may be stored in either a dry ingredient storage module 14a or a liquid ingredient storage module 14b according to the nature of the ingredients. In various embodiments, the likwifier 16 may be capable of mid to high sheer mixing, liquefying ingredients, and/or cycling the ingredients to and from the blend tank 18. The blend tank 18 is generally capable of receiving water from water module 20 (e.g., a water tank), and receiving and cycling liquefied ingredients to and from likwifier 16. The blend tank 18 may be further capable of blending ingredients at lower speeds than likwifier 16 and/or subjecting contents to an agitation cycle. TABLES 1 through 3 below are example formulas illustrating particular ingredients that may be mixed by the batching system of FIG. 1 to make a beverage that includes coconut according to various embodiments.

The processing module 22 illustrated in FIG. 1 is generally capable of: preheating the product blended by blend tank 18, exposing the product to steam injection and homogenization, cooling the product, and sending the cooled product to aseptic storage 24. The filling module 26 is generally capable of bottling or packaging the stored product in preparation for distribution. Although batching system 10 includes a number of elements or modules in this example, other embodiments may include one or more of these or other elements, or may exclude these elements without departing from the scope of the present disclosure.

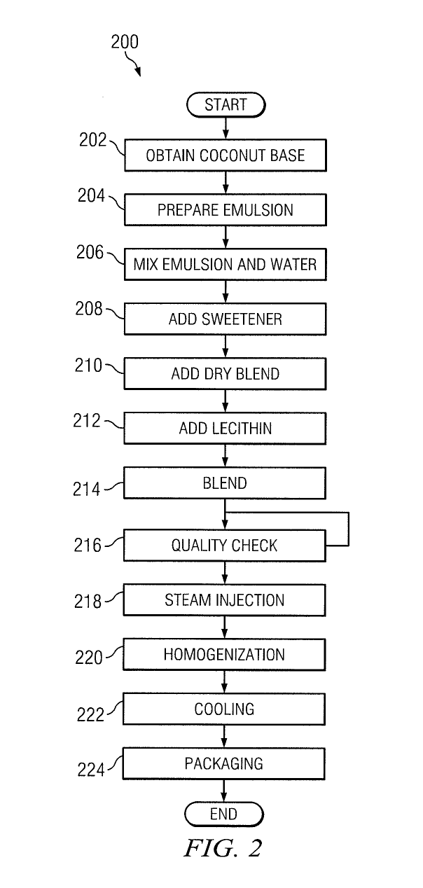

FIG. 2 is one example of a flow diagram 200 illustrating a method for making a beverage that includes coconut according to a particular embodiment. The method begins at step 202 by obtaining a coconut base. In this example, the coconut base comprises coconut cream, however, other embodiments may use any other suitable coconut base, such as coconut cream, coconut milk, coconut powder, coconut puree, or a combination without departing from the scope of the invention. In some embodiments, the coconut base may be full fat, reduced fat, or fat free.

At step 204, the coconut base may be emulsified. Emulsifying the coconut base may prevent the medium chain fatty acids from disassociating from the solution and rising to the top of the finished product. Thus, the fat found in the coconut cream may remain in solution over the shelf life of the finished product. As an example, the emulsion may be created according to a conventional method by mixing an aqueous medium, a fat, and an emulsifier using a mixer capable of mid to high speed mixing. Examples of the aqueous medium used in the preparation of the emulsion include water, purified water, deionized water, distilled water, and the like. Examples of emulsifiers include gums, such as carrageenan gum, gellan gum, xanthan gum, locust bean gum (LBG), guar gum, gum acacia, and the like, or other emulsifiers, such as mono-glycerides and di-glycerides. In some embodiments, the emulsion formed may comprise an oil-in-water (OW) emulsion. The emulsion may comprise any suitable amount of oil, such as 0.5 to 50% oil.

In step 206, the coconut emulsion is mixed with the remaining formula water. In particular embodiments, the process of mixing the coconut emulsion with water may include cycling the mixture of water and the coconut emulsion between a blend tank and a likwifier of the batching system.

In step 208, one or more sweeteners and/or flavorings may be added to the batching system. In various embodiments, nutritive, non-nutritive, or nutritive and non-nutritive combinations of natural and/or artificial sweeteners may be added.

Examples of nutritive sweeteners include natural evaporated sugar cane juice and/or other sugars. Examples of non-nutritive natural sweeteners include stevia extracts (e.g., steviol glycosides, such as rebaudioside A). Examples of artificial sweeteners may include saccharin, aspartame, sucralose, neotame, and acesulfame potassium. Examples of flavorings include vanilla, coconut, cocoa powder, strawberry, chocolate, or some other suitable natural, organic, or artificial flavoring, or a combination. Although the example describes the use of sugar, other embodiments may be entirely or substantially free of sugar, such as unsweetened formulations or formulations that include a sugar substitute. In some embodiments, the beverage may remain unflavored. The term “flavoring” as used herein generally refers to any substance that may be safely used in food, the function of which is to impart flavor.

In step 210, a dry blend may be added to the batching system. According to various embodiments, the dry blend may be a powder mixture that includes one or more health-related supplements, one or more salts, and/or one or more hydrocolloids.

In some embodiments, the health-related supplements of particular dry blends may include one or more of the following: calcium carbonate (CaCO3), vitamin A, vitamin B2, vitamin B12, vitamin D, vitamin E, zinc, fiber, protein, potassium, phosphorus, fatty acids (e.g., omega 3, omega 6, etc.), oligosaccharide, and/or any other suitable health-related supplement. In various embodiments, the one or more health-related supplements may be selected based at least in part on a neutral-taste quality that may have little or no impact on the overall taste of the product. In particular embodiments, the addition of the salts of potassium and phosphate ions may provide both a source of both potassium and phosphorus. In some embodiments, fiber may be provided by the addition of dextrin (e.g., Nutriose), polydextrose, and/or some other suitable dietary or non-dietary fiber source.

In some alternative embodiments, one or more protein-based supplements may optionally be added in step 210. In particular embodiments, the one or more protein-based supplements may comprise a soy derived protein or a protein that is substantially free of soy-protein, such as, for example yellow pea protein, potato protein, and/or any other suitable non-soy protein-based supplement.

In particular embodiments, the one or more salt agents of various dry blends may include one or more of the following: sea salt (e.g., sodium chloride), a potassium phosphate (e.g., monopotassium phosphate (KH2PO4), dipotassium phosphate (K2HPO4), tripotassium phosphate (K3PO4) etc.), a sodium phosphate (e.g., disodium phosphate (Na2HPO4)), a calcium phosphate (e.g., tricalcium phosphate Ca3(PO4)2), a citrate salt, and/or any other suitable emulsifying, flavoring, stabilizing, and/or buffering agent or combination of agents. As shown in several example formulations below, particular salt combinations may improve dispersion of the non-soy based protein, provide enhanced product stability, and round out the flavor profile. In certain embodiments, the one or more salt agents of various dry blends may be substantially free of buffering salts.

In some embodiments, the hydrocolloids of particular dry blends may include one or more of the following: pectin, any suitable starch, gum (e.g., gellan gum, xanthan gum, locust bean gum (LBG), guar gum, carrageenan gum, gum acacia, or cellulose) and/or any other hydrocolloid. In some cases, the particular hydrocolloid or combination of hydrocolloids optionally added in step 210 may be chosen for properties other than or in addition to stabilization. For example, some hydrocolloid(s) may contribute to optimal suspension, mouth feel, or some other desirable feature. In some embodiments, hydrocolloids may be added in step 204 to prepare the emulsion without requiring the addition of more hydrocolloids in step 210.

Although particular example embodiments are described as optionally including one or more health-related supplements, one or more salts, and/or one or more hydrocolloids, the dry blend added in step 210 may include various alternative or additional ingredients. Additionally, although a dry blend is used in this example, in alternative embodiments one or more of the ingredients added in step 210 may be introduced to the batching system separately from the other ingredients of step 210 and/or one or more of the ingredients added in step 210 may be introduced to the batching system in a form other than a dry powder (e.g., in a liquid form).

In particular embodiments, using pre-mixed dry blends in step 210 may provide enhanced quality control while reducing product variation. For example, premixing ingredients of a dry blend may mitigate clumping, incomplete dispersion, and/or incomplete hydration that might otherwise occur if particular ingredients are added individually to a batching system. Additionally, if multiple ingredients are introduced as a pre-mixed dry blend, then it may not be necessary to measure and introduce into a batching system each ingredient individually. Some pre-mixed dry blends may be readily transported, stored, divided, measured, and/or added to mixtures in highly controlled quantities with minimal waste. Furthermore, the exact composition of particular dry blends in terms of individual ingredients and their respective percentage weights may not be readily determinable if these ingredients are pre-mixed in a controlled setting.

In step 212, a lecithin may be introduced to the batching system. According to one embodiment, the lecithin may be substantially or entirely free of soy or soy-derived ingredients (e.g., a sunflower-based lecithin). Using one or more substantially soy-free lecithins may, in certain embodiments, enable increasing the percentage content of a more neutral-tasting lecithin beyond thresholds for soy-derived lecithins at which an increase in the soy-derived lecithin may negatively affect taste and/or mouth feel. Although various embodiments may add a lecithin that is substantially or entirely free of soy or soy-derived ingredients, alternative embodiments may use one or more alterative lecithins or no lecithin. Embodiments that are substantially or entirely free of soy or soy-derived ingredients may enable production of a non-dairy beverage that may be consumed, for example, by those who do not consume dairy products or soy products for reasons related to digestion, allergies, taste, and/or other reasons. Additionally, unlike non-dairy milk products that contain a lecithin derived at least partially from genetically modified soy beans or some other genetically modified organism (GMO), particular embodiments may use one or more lecithins that are not derived from genetically modified organisms. Other embodiments may be substantially or entirely free of lecithin.

In embodiments including one or more non-soy or non-GMO-based lecithins in powder form, the lecithin(s) may alternatively be included within the dry blend of step 210. In particular embodiments, however, the lecithin optionally added in step 212 may be in liquid form and may have a high enough viscosity to justify adding the lecithin(s) in a separate step, which in some cases may enhance dispersion.

Once the selected ingredients have been added, the combined mixture, the “product,” may be allowed to blend in step 214 for three to ten minutes (e.g., five minutes) or any other suitable duration of time. According to one embodiment, the blending may include circulating the product between the likwifier and the batch tank of a batching system. Additionally, the blending may further include a low-speed agitation for an additional five to fifteen minutes (e.g., ten minutes) or any other suitable duration of time. In particular embodiments, the batch tank of the batching system may be capable of performing the optional low-speed agitation.

In step 216, a quality check may be performed. For example, a product sample may be pulled from the batch tank and analyzed for solids, fat content, proper pH balance, levels of vitamins and nutrients, consistency, etc. The results of this quality check may be used, for example, to make a variety of adjustments for optimization purposes or quality control. For example, if it is determined that the product sample contains solids that exceed a quantity and/or granularity threshold, additional mixing may be performed, additional agitation may be performed, and/or additional water may be added and mixed with the contents of the batching system. As another example, if it is determined that the product sample contains solids that are less than a quantity and/or granularity threshold, solids may be added to the product (e.g., in the form of sugar, coconut, and/or some other ingredient). Step 216 may be repeated until it is determined that the product meets a predetermined quality standard.

In step 218, the product may be processed through a direct steam injection processor. In particular embodiments, the product may be pumped through a pre-heater, which may raise the product temperature from about 35 to 70 degrees Fahrenheit to within the range of 150 to 200 degrees Fahrenheit (e.g., 178 degrees Fahrenheit). The pre-heated product may then flow through stainless steel tubing, where steam may be directly injected into product as it flows. The tubing may have a specified length based on the flow rate to achieve a product temperature within the range of 250 and 300 degrees Fahrenheit (e.g., 282 degrees Fahrenheit). After processing through a direct steam injection processor, the product may be introduced to a flash chamber that removes substantially all of the steam that may have been added. Although direct heat is used in this example, indirect heat may be used (e.g., heat transfer through indirect plates, tube-in-tube, tube-in-shell, etc.).

In step 220, the product is homogenized. In a particular embodiment, homogenization may be accomplished by passing the product under high pressure through a small orifice. For example, the product may be exposed to a maximum homogenization pressure of approximately 500 to 4000 pounds per square inch (psi) (e.g., 3000); however, any suitable maximum pressure may be used. In various embodiments, homogenization may be accomplished using two stages, each with a different pressure (e.g., approximately 2000 psi at a second stage and approximately 500 psi at a first stage). In an alternative embodiment, an ultra-high homogenization pressure (UHP) may be used. For example, the product may be exposed to a maximum homogenization pressure of greater than approximately 20,000 psi, such as approximately 25,000 psi. Exposing the product to UHP processing may, in some cases, provide stabilizing properties to the product in a manner similar to some hydrocolloids. Thus, particular embodiments using UHP processing may be substantially or entirely free of hydrocolloids.

In step 222, the product is cooled to a temperature within the range of 32 to 45 degrees Fahrenheit. The product may then be transferred to an aseptic tank cooler until it is called to a filler system for bottling or packaging in preparation for distribution.

In step 224, the product may be introduced into, and enclosed within, sanitized containers. In particular embodiments, the product may be sealed within a single-serve package (e.g., a package containing 3-20 fluid ounces); bag-in-box (e.g., a pouch within a box), pint-sized, half-gallon, full-gallon containers, and/or some other suitable container. The method then ends.

Example formulations that may be used to produce non-dairy, coconut-based beverage according to various embodiments are described further below with reference to TABLES 1 through 3. Each of the example formulations shown in TABLES 1 through 3 is substantially or entirely free of soy or soy-derived ingredients.

TABLE 1

| | % | g |
|---|---|---|
| Coconut Cream | 4.25 | 382.5 |
| Water | 93.2776 | 8394.98 |
| Sugar | 2.0 | 180 |
| CaCO3 | 0.3 | 27 |
| VitA | 0.00155 | 0.1395 |
| VitD | 0.00085 | 0.0765 |
| Vitamin B12 | 0.001 | 0.9 |
| Cellulose Gel | 0.03 | 2.7 |
| Guar gum | 0.09 | 8.1 |
| Sunflower Lecithin | 0.04 | 3.6 |
| | 100.00 | 9000 |

TABLE 2

| | % | g |
|---|---|---|
| Coconut Cream | 4.25 | 382.5 |
| Water | 93.3176 | 8398.58 |
| Sugar | 2.0 | 180 |
| CaCO3 | 0.3 | 27 |
| VitA | 0.00155 | 0.1395 |
| VitD | 0.00085 | 0.0765 |
| Vitamin B12 | 0.001 | 0.9 |
| Cellulose Gel | 0.03 | 2.7 |
| Guar gum | 0.09 | 8.1 |
| | 100.00 | 9000 |

TABLE 3

| | % | g |
|---|---|---|
| Coconut Cream | 6.25 | 562.5 |
| Water | 91.3726 | 8223.53 |
| Sugar | 2.0 | 180 |
| CaCO3 | 0.3 | 27 |
| VitA | 0.00155 | 0.1395 |
| VitD | 0.00085 | 0.0765 |
| Vitamin B12 | 0.001 | 0.9 |
| Carrageenan Gum | 0.065 | 5.85 |
| | 100.00 | 9000 |

The example formula of TABLE 1 includes a lecithin. In particular, the formula of TABLE 1 includes sunflower lecithin in the amount of approximately 0.04% total weight (e.g., 3.6 grams for each 9000 grams). Although the formula of TABLE 1 shows 0.04% sunflower lecithin by weight, any desired percentage of sunflower lecithin by weight or volume and/or one or more alternative soy-free lecithins may be used. For example, alternative embodiments may include sunflower lecithin within the range of 0% to 0.06% of total weight or volume. Although this embodiment includes a sunflower lecithin, other embodiments may include one or more alternative lecithins or may exclude a lecithin altogether without departing from the scope of the present disclosure.

The formula of TABLE 1 further includes coconut cream in the amount of approximately 4% total weight (e.g., 360 grams for each 9000 grams), however, any suitable percentage weight or volume of coconut cream and/or other coconut-derived ingredient may be used. For example, alternative embodiments may include an amount of coconut cream less than approximately 20% of total weight or volume, such as an amount of coconut cream within the range of 1% to 10% of total weight or volume. Although this embodiment includes coconut cream, other embodiments may include one or more alternative coconut pastes, flours, and/or purees without departing from the scope of the present disclosure.

The formula of TABLE 1 further includes example amounts of health supplements, however, any suitable percentage weight or volume of any suitable health supplement may be used, including the exclusion of health supplements entirely. For example, alternative embodiments may include as a fractional portion of total weight or volume: 0% to 0.75% calcium carbonate (CaCO3), 0% to 0.002% vitamin A, 0% to 0.01% vitamin D, 0 to 3% dextrin, soy-free or soy-derived protein, and/or a fractional portion consisting of one or more alternative health supplements. Although this embodiment includes certain health-related supplements, other embodiments may include these and/or other desired health-related supplements without departing from the scope of the present disclosure.

The formula of TABLE 1 further includes example amounts of gums, however, any suitable percentage weight or volume of any suitable gums may be used, including the exclusion of gums entirely. For example, alternative embodiments may include as a fractional portion of total weight or volume: 0% to 0.10% gellan gum, 0% to 1.2% locust bean gum, 0% to 1.2% guar gum, 0% to 5% gum acacia, 0% to 1.2% carrageenan gum, and/or a fractional portion consisting of one or more alternative gums. Although this embodiment includes certain gums, other embodiments may include these and/or other desired hydrocolloids without departing from the scope of the present disclosure.

The formula of TABLE 1 further includes sugar in the amount of approximately 2% total weight (e.g., 180 grams for each 9000 grams), however, any suitable sweetener and/or flavoring consisting of any suitable percentage weight or volume of the total weight of volume may be used. For example, some embodiments may include, as a fractional portion of total weight or volume, 0% to 10% sugar. Although this embodiment includes sugars, other embodiments may include these and/or other desired flavorings (e.g., vanilla, chocolate, cocoa powder, fruit flavorings) without departing from the scope of the present disclosure.

In some embodiments, water may comprise the balance of the formula. For example, alternative embodiments may include water within the range of 80% to 95% of total weight or volume.

The components of the systems and apparatuses disclosed herein may be integrated or separated. Moreover, the operations of the systems and apparatuses may be performed by more, fewer, or other components. The methods may include more, fewer, or other steps. For example, in various embodiments, some or all of the sugar optionally added in step 208 and/or the lecithin optionally added in step 212 may form a portion of the dry blend added in step 210, such that steps 208 and/or 212 may be wholly or partially combined with step 210. Additionally, steps may be performed in any suitable order.

Although the present disclosure has been described above in connection with several embodiments, a myriad of changes, substitutions, variations, alterations, transformations, and modifications may be suggested to one skilled in the art, and it is intended that the present invention encompass such changes, substitutions, variations, alterations, transformations, and modifications as fall within the spirit and scope of the appended claims. For example, although the present disclosure has been described in the context of mass production, the teachings of the present disclosure may be applied on a smaller scale. In particular, the ingredients disclosed herein may be combined and mixed manually as opposed to combining and/or mixing the ingredients by machine.

To aid the Patent Office, and any readers of any patent issued on this application in interpreting the claims appended hereto, applicants wish to note that they do not intend any of the appended claims to invoke paragraph 6 of 35 U.S.C. §112 as it exists on the date of filing hereof unless the words “means for” or “step for” are explicitly used in the particular claim.

What is claimed is:

1. A method, comprising:
mixing an aqueous medium, a coconut base, and an emulsifier to yield an emulsion;
adding one or more other ingredients to the emulsion;
blending the emulsion and the one or more other ingredients to yield a coconut-based beverage, wherein the coconut-based beverage is substantially free of dairy-derived ingredients.

2. The method of claim 1, wherein the beverage is substantially free of soy-derived ingredients.

3. The method of claim 1, the one or more other ingredients including a flavoring.

4. The method of claim 1, the one or more other ingredients including a stevia extract.

5. The method of claim 1, the one or more ingredients including a health supplement.

6. The method of claim 1, wherein the emulsion comprises an oil-in-water emulsion.

7. The method of claim 1, wherein:
the coconut base comprises at most ten percent of the net weight of the beverage; and
the coconut base comprises coconut cream;
the emulsifier comprises gellan gum, guar gum, carrageenan gum, locust bean gum, gum acacia, or xanthan gum; and
the one or more other ingredients comprises:
a sunflower-based lecithin;
a sugar;
one or more health supplements comprising vitamin A, vitamin D, vitamin B12, and calcium.

8. The method of claim 1, further comprising:
preheating the beverage to a temperature within the range of approximately 150 to 200 degrees Fahrenheit;
exposing the beverage to steam injection; and
homogenizing the beverage using a maximum homogenization pressure of at least 2,000 pounds per square inch.

9. The method of claim 1, wherein the beverage is substantially free of lecithin and substantially free of salts.

10. The method of claim 1, wherein:
the aqueous medium comprises water, the water present in an amount in the range of 80 to 95% of net beverage weight;
the coconut base comprises coconut cream, the coconut cream present in an amount less than 20% of the net beverage weight;
the emulsifier comprises carrageenan gum, the carrageenan gum present in an amount less than 1.2% of the net beverage weight;
the one or more other ingredients comprises vitamin A, vitamin B12, vitamin D, calcium, and sugar; and
the beverage is substantially free of lecithin and substantially free of salts.

11. The method of claim 1, further comprising exposing the beverage to indirect heating to yield a product temperature within the range of 250 and 300 degrees Fahrenheit.

12. A beverage, comprising:
a coconut base;
an emulsifier selected to yield an oil-in-water emulsion when combined with the coconut base; and
a sweetener;
wherein the beverage is substantially free of dairy-derived ingredients.

13. The beverage of claim 12, wherein the beverage is substantially free of soy-derived ingredients.

14. The beverage of claim 12, further comprising a flavoring.

15. The beverage of claim 12, wherein the sweetener includes rebaudioside A.

16. The beverage of claim 12, further comprising a health supplement.

17. The beverage of claim 12, wherein:
the coconut base comprises at most ten percent of the net weight of the beverage; and
the coconut base comprises coconut cream;
the sweetener comprises sugar;
the emulsifier comprises gellan gum, guar gum, carrageenan gum, locust bean gum, gum acacia, or xanthan gum; and
the beverage further comprises:
a sunflower-based lecithin; and
one or more health supplements comprising vitamin A, vitamin D, vitamin B12, and calcium.

18. The beverage of claim 12, wherein the beverage is substantially free of salts.

19. The beverage of claim 12, wherein the coconut base comprises medium chain fatty acids; and
the emulsifier selected to retain the medium chain fatty acids in solution over the shelf life of the beverage.

20. The beverage of claim 12, wherein the beverage is substantially free of lecithin and substantially free of salts.

21. The beverage of claim 12, wherein:
the coconut base comprises coconut cream, the coconut cream present in an amount less than 20% of the net beverage weight;
the emulsifier comprises carrageenan gum, the carrageenan gum present in an amount less than 1.2% of the net beverage weight;
the beverage further comprising:
water present in an amount in the range of 80 to 95% of net beverage weight;
a plurality of health supplements comprising vitamin A, vitamin B 12, vitamin D, and calcium; and
wherein the beverage is substantially free of lecithin and substantially free of salts.

22. The beverage of claim 12, wherein the sweetener includes an artificial sweetener.
